(19) United States
(12) Patent Application Publication
(10) Pub. No.: US 2005/0108762 A1
(43) Pub. Date: May 19, 2005

(54) Wireless audio-video transmission apparatus

(75) Inventors: Yung-Sung Chao, Chung Ho City (TW); Kao-Yi Shen, Chung Ho City (TW); Jui-Hsiang Yang, Chung Ho City (TW); Ming-Hou Dai, Chung Ho City (TW)

Correspondence Address: SUGHRUE MION, PLLC, 2100 PENNSYLVANIA AVENUE, N.W., SUITE 800, WASHINGTON, DC, 20037, US

(73) Assignee: AverMedia TECHNOLOGIES, INC.

(21) Appl. No.: 10/812,063

(22) Filed: Mar. 30, 2004

(30) Foreign Application Priority Data
Nov. 17, 2003 (TW) 92132184

(51) Int. Cl. H04N 5/44; H04N 5/50; H04N 7/18

(52) U.S. Cl. 725/81; 348/731; 725/80

(57) ABSTRACT

The present invention provides a wireless audio-video transmission apparatus. This apparatus can convert the required audio-video signal from the cable line into wireless signal for broadcast. The receivers located within broadcast range can receive the required wireless signal.

### FIELD OF THE INVENTION

The present invention relates to a transmission apparatus and more particularly to a wireless audio-video transmission apparatus.

### BACKGROUND OF THE INVENTION

Television has served as an audio and video information supplier for a long time. People can obtain weather predictions, the latest news, entertainment information and so on from television. However, television is, in fact, only a display apparatus. Additional audio and video information need to be supplied to the television for conversion into image information to display. Therefore, a cable connected with a television is required to receive the audio and video information.

However, typically, the television cable line is only installed in the living room. Therefore, if the television is placed in another room, an additional cable line is required. In other words, the user needs to install another cable line in the room. Such additional installed cable line requirement is inconvenient for a user.

On the other hand, an additional TV card or TV box needs to be installed in a computer if the user uses a display apparatus of this computer to receive audio and video information from the cable line. Therefore, even though the cable line has been installed in a room, an additional signal line is still needed to transfer the audio and video information from the cable line to the TV card or TV box.

### SUMMARY OF THE INVENTION

Therefore, it is the main object of the present invention to provide a wireless audio-video transmission apparatus. According to the present invention, the audio-video information is sent by a wireless method. Therefore, it is not necessary to use the additional installed cable line.

Another object of the present invention is to provide a wireless audio-video transmission apparatus to send wirelessly the audio-video information to the room without installing cable line.

Yet another object of the present invention is to provide a wireless audio-video transmission apparatus to send wirelessly the audio-video information to a remote display apparatus.

Accordingly, the present invention provides a wireless audio-video transmission apparatus. This apparatus can convert the required audio-video signal from the cable line into a wireless signal for broadcast. The receivers located within broadcast range can receive the required wireless signal.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of using the wireless audio-video transmission apparatus of the present invention to send audio-video information; and

FIG. 2 illustrates a schematic diagram of the wireless audio-video transmission apparatus of the present invention.

### DETAILED DESCRIPTION OF THE PREFERRED EMBODIMENT

Without limiting the spirit and scope of the present invention, the circuit structure proposed in the present invention is illustrated with one preferred embodiment. One with ordinary skill in the art, upon acknowledging the embodiment, can apply the wireless audio-video transmission apparatus of the present invention to various transmission usages. In general, an additional installation is always needed to extend the transmission range when using the cable line to send the audio-video information, which is inconvenient for the user. Therefore, the present invention provides a wireless audio-video transmission apparatus to send wirelessly the audio-video information to a remote display apparatus. The present invention can be understood by the following detailed embodiment. However, the embodiment does not limit the scope of the present invention.

Typically, the tevesion is always placed wherever the cable line is located. Therefore, if the user want to change the position of the television, an additional installation is needed for extending the transmission range. Therefore, the present invention provides a wireless audio-video transmission apparatus. According to the present invention, the audio-video information is sent by a wireless method. Therefore, it is not necessary to use the additional installed cable line.

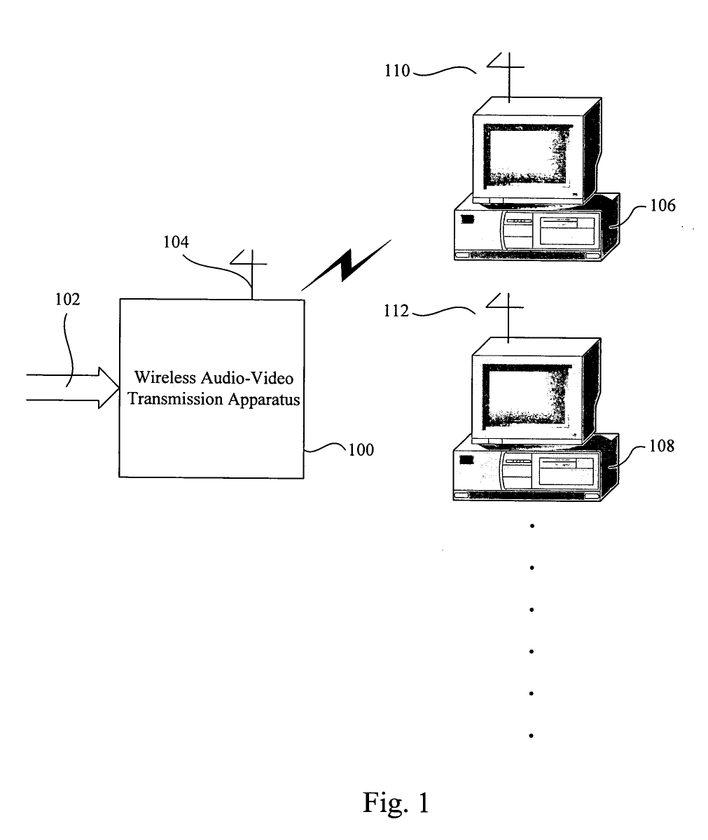

FIG. 1 illustrates a schematic diagram of using the wireless audio-video transmission apparatus to send audio-video information. The receiver 106 with an antenna 110 can send a channel requirement signal to the wireless audio-video transmission apparatus 100 of the present invention. After the channel requirement signal is received through the antenna 104, the wireless audio-video transmission apparatus 100 can collect the corresponding audio-video information from the cable line 102. Then, this audio-video information is decoded and is compressed by the wireless audio-video transmission apparatus 100. Next, the compressed audio-video information is sent to the receiver 106 through the wireless audio-video transmission apparatus 100. After the receiver 106 receives and decompresses the compressed audio-video information, the required channel can be displayed in the display apparatus. The display apparatus is a CRT or a LCD. It is noted that the receiver 106 is an apparatus that can receive the wireless signal, such as, for example, a portable computer, mobile apparatus or notebook. Moreover, the specification of the wireless signal is 802.11XX according to the preferred embodiment. However, other types wireless signal specification also can be used in the present invention.

In other words, the wireless audio-video transmission apparatus 100 of the present invention can convert the audio-video signal of the required channel from the cable line into a wireless signal for broadcast. The receivers 106 located within broadcast range can receive the broadcast wireless signal and display the required channel. On the other hand, a plurality of receivers 106 can only use a wireless audio-video transmission apparatus 100. The wireless audio-video transmission apparatus 100 can select the corresponding audio-video information that each receiver requires to send to the receiver 106.

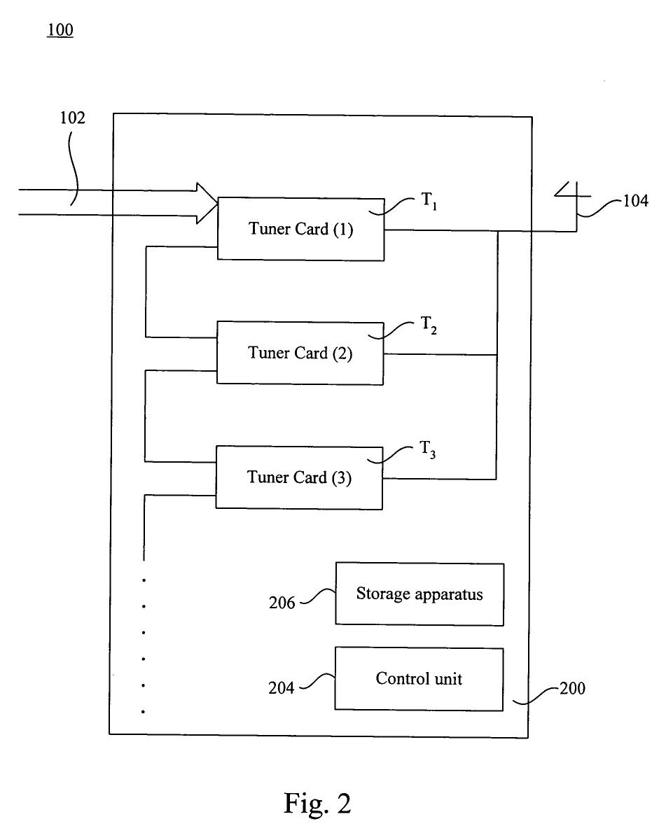

FIG. 2 illustrates a schematic diagram of the wireless audio-video transmission apparatus of the present invention. The wireless audio-video transmission apparatus comprises a motherboard 200, a control unit 204 and at least one tuner card T. A plurality of tuner cards T₁, T₂. . . Tₑₙ is used in the preferred embodiment of the present invention. The tuner card is connected with the motherboard 200 through a PCI plug. However, another connection method can also be used. These tuner cards T₁, T₂, . . . Tₙ are connected with a cable line 102 to receive the audio-video signal with special frequency and bandwidth. Then, the audio-video signal is demodulated to standard audio-video signal that can be displayed in a display apparatus. The displayed audio-video signal is broadcast through an antenna 104.

These tuner cards T₁, T₂. . . Tₙ are connected in series on the motherboard 200 to share the audio-video information sent from the cable line 102. A receiver sends a channel requirement signal to the wireless audio-video transmission apparatus 100 of the present invention. After the channel requirement signal is received, the control unit 204 can activate any idle tuner card to collect the audio-video information of the required channel from the cable line 102. Then, this collected audio-video information is sent to the receiver that issues the requirement signal through the antenna 104. It is noted that a storage apparatus 206 can also be installed in the wireless audio-video transmission apparatus 100 in another embodiment. The control unit 204 can control the storage apparatus 206 to store the audio-video information. In other words, the wireless audio-video transmission apparatus 100 of the present invention also can record the audio-video information according to the requirement of the receiver. It is noted that the receiver can directly record the received audio-video information in its storage apparatus, such as a hard disk.

Referring to FIG. 1 and FIG. 2, the receiver 106 with an antenna 110 sends out a first channel requirement signal to the wireless audio-video transmission apparatus 100 of the present invention. After the channel requirement signal is received through the antenna 104, the control unit 204 can activate tuner card T₁, if the tuner card T₁ is idle, to collect the audio-video information of the required channel from the cable line 102. This collected audio-video information is decoded and is compressed by the wireless audio-video transmission apparatus 100. Next, the compressed audio-video information is sent to the receiver 106 through the antenna 104. After the receiver 106 receives and decompresses the compressed audio-video information, the required channel can be displayed in the display apparatus. At this time, if another receiver 108 also sends out channel requirement signal to the wireless audio-video transmission apparatus 100 through its antenna 112, the control unit 204 can activate another tuner card T₂, if the tuner card T₂ is idle, to collect the audio-video information of the required channel from the cable line 102. This collected audio-video information is decoded and is compressed by the wireless audio-video transmission apparatus 100. Next, the compressed audio-video information is sent to the receiver 108 through the antenna 104. After the receiver 108 receives and decompresses the compressed audio-video information, the required channel can be displayed in the display apparatus. It is noted that the receiver 106 or 108 also can issue a recording channel requirement to the wireless audio-video transmission apparatus 100. The control unit 204 can control the storage apparatus 206 to store the required audio-video information.

On the other hand, the wireless audio-video transmission apparatus 100 also can send out the audio-video information of Picture In Picture. For example, when the receiver 106 issues a requirement signal of two channel to display Picture In Picture, the control unit 204 can activate two tuner cards T₃ and T₄, if both tuner cards T₃ and T₄ are idle, to collect the audio-video information of the required channels from the cable line 102 after the requirement signal is received by the wireless audio-video transmission apparatus 100. This collected audio-video information is decoded and is compressed by the wireless audio-video transmission apparatus 100. Next, the compressed audio-video information is sent to the receiver 106 through the antenna 104. After the receiver 106 receives and decompresses the compressed audio-video information, the required channels can be displayed in the display apparatus. It is noted that the wireless audio-video transmission apparatus 100 of the present invention also can send out audio-video information of a plurality of channels to a receiver if there are enough tuner cards to handle the required audio-video information.

On the other hand, an allocation software can be installed in the wireless audio-video transmission apparatus 100 of the present invention to allocate the tuner cards. For example, only three tuner cards are used in a wireless audio-video transmission apparatus 100, in which a receiver uses two tuner cards to display picture-in-picture of two channels and the other receiver uses the other tuner card to display a channel. At this time, if another receiver issues a requirement to the wireless audio-video transmission apparatus 100, the allocation software forces allocation of a tuner card of the receiver that uses two tuner cards to another receiver.

Accordingly, the present invention provides a wireless audio-video transmission apparatus to send wirelessly the audio-video information to the remote display apparatus. Therefore, it is not necessary to install additional cable line for extending the transmission range.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

1. A wireless audio-video transmission apparatus, wherein said apparatus is coupled to a cable line for wirelessly transmitting audio-video signal to at least one receiver, comprising:
a wireless device for receiving a channel requirement signal from said at least one receiver and transmitting corresponding audio-video signal to said at least one receiver;
a control unit coupling with said wireless device to receive said channel requirement signal through said wireless device; and
at least one tuner card coupling with said cable line and connected in series, wherein said control unit controls said at least one tuner card to collect corresponding audio-video signal and convert said corresponding audio-video signal into a standard signal for display by a display apparatus.

2. The wireless audio-video transmission apparatus of claim 1, wherein said at least one receiver is a portable computer, a mobile apparatus or a notebook.

3. The wireless audio-video transmission apparatus of claim 1, wherein said display apparatus is a liquid crystal display.

4. The wireless audio-video transmission apparatus of claim 1, wherein a specification of the signal transmitted by said wireless device is 802.11XX.

5. The wireless audio-video transmission apparatus of claim 1, wherein said wireless device is an antenna.

6. The wireless audio-video transmission apparatus of claim 1, wherein said wireless audio-video transmission apparatus further comprises a software to allocate usage of said tuner cards.

7. The wireless audio-video transmission apparatus of claim 1, wherein said wireless audio-video transmission apparatus further comprises a storage apparatus for storing said standard signal.

8. A wireless audio-video transmission system, comprising:
at least one receiver with a display apparatus; and
a wireless audio-video transmission apparatus coupling with a cable line for wirelessly transmitting audio-video signal to at least one receiver, comprising:
a wireless device for receiving a channel requirement signal from said at least one receiver and transmitting corresponding audio-video signal to said at least one receiver;
a control unit coupling with said wireless device to receive said channel requirement signal through said wireless device;
and
at least one tuner card coupling with said cable line and connected in series, wherein said control unit controls said at least one tuner card to collect corresponding audio-video signal and convert said corresponding audio-video signal into a standard signal for display by said display apparatus.

9. The wireless audio-video transmission system of claim 8, wherein said at least one receiver is a portable computer, a mobile apparatus or a notebook.

10. The wireless audio-video transmission system of claim 8, wherein said display apparatus is a liquid crystal display.

11. The wireless audio-video transmission system of claim 8, wherein a specification of the signal transmitted by said wireless device is 802.11XX.

12. The wireless audio-video transmission system of claim 8, wherein said wireless device is an antenna.

13. The wireless audio-video transmission system of claim 8, wherein said wireless audio-video transmission apparatus further comprises a software to allocate usage of said tuner cards.

14. The wireless audio-video transmission system of claim 8, wherein said wireless audio-video transmission apparatus further comprises a storage apparatus for storing said standard signal.
